(19) United States
(12) Patent Application Publication
(10) Pub. No.: US 2020/0226668 A1
(43) Pub. Date: Jul. 16, 2020

(54) Shopping system with virtual reality technology

(71) Applicant: SPEED 3D Inc., Taipei City (TW)

(72) Inventors: Li-Chuan Chiu, Taipei City (TW); Jui-Chun Chung, Taipei City (TW); Hui-Chun Chen, Taipei City (TW); Yi-Ping Cheng, Taipei City (TW)

(21) Appl. No.: 16/388,810

(22) Filed: Apr. 18, 2019

(30) Foreign Application Priority Data
Jan. 14, 2019 (CN) 201910031339.0

(51) Int. Cl. G06Q 30/06; G06Q 50/00; G06T 11/60; G06T 15/00

(52) U.S. Cl. CPC G06Q 30/0643; G06T 15/00; G06T 11/60; G06Q 50/01

(57) ABSTRACT

A shopping system with virtual reality technology is run in an portable device. The shopping system has a virtual space generator, an augmented reality (AR) module, a positioning module, and a shopping module. The AR module is used to generate an AR image that would be imported to the virtual space generator. The positioning module is used to obtain a position and orientation of the portable device and import the position and orientation to the virtual space generator to change a movement position of a view point in the virtual space. Cooperating with a commodity service unit and a shopping guiding module, the 3D product content in the commodity service unit can be imported the virtual space. Then, the detail of the commodity can be obtained in the virtual space, and the commodity can be matched with the background. A custom can place the order via the shopping guiding module.

### CROSS REFERENCE TO RELATED APPLICATION

This application claims the benefit of China application No. 201910031339.0, filed on Jan. 14, 2019, the contents of which are incorporated herein in their entirety.

### BACKGROUND OF THE INVENTION

### 1. Field of the Invention

The invention relates to a shopping system and, more particularly, to a shopping system with virtual reality technology.

### 2. Description of the Prior Art

Augmented reality (AR) is a technology application based on recognition of image features. Images captured by capturing devices (such as lens of a personal notebook or a mobile device) are identified by the image identification program. The corresponding image card or feature points of a target image are detected, and the displacement, rotating, and zooming of the image in the space is calculated. Then, characters, two-dimensional or three-dimensional information are projected. With the AR technology, the notebook information can be integrated to the real world. As a result, users can see reality information integrated with the virtual reality.

With the rapid development of the global information technology, the internet and knowledge economy become important to human life which tends to be networked and intelligent. The shopping mode is gradually changed from previous on-site shopping to the combine of an experience store and the online shopping. Instead of the way of going to the mall or the retail store to select a product one by one, people can select the product after logging in the shopping website through the notebook or the intelligent mobile device. Then, the selected product is delivered to the user, which is very convenient. However, the new shopping mode has many defects. For example, the commodity does not meet the use environment, so that the return rate is increased. Furthermore, the detail style of the commodity is not clear enough just through the online picture.

### SUMMARY OF THE INVENTION

A shopping system with the virtual reality technology is provided. The system is incorporated with an application program (APP) and run in a portable device. The system includes a virtual space generator configured to generate a virtual space; an augmented reality (AR) module configured to generate the AR image, the AR image is imported to the virtual space generator; a positioning module configured to obtain a position and orientation of the portable device and import the position and orientation to the virtual space generator to change a movement position of a view point in the virtual space; and a shopping module connected with the AR module and configured to obtain commodity information of an identification image. The commodity information is imported to the virtual space generator to generate a 3D product content.

In an embodiment, the shopping module includes a commodity service unit, and the commodity information generated by the shopping module is accessible via detection of the identification image.

In an embodiment, the shopping module provides a browse mode, and the 3D product content with the commodity information is imported to the virtual space generator and displayed on a display screen of the portable device when in the browse mode.

In an embodiment, the shopping module includes a chat module, and an instant conversation channel is built between the social network website including the 3D product content and the portable device via the chat module.

In an embodiment, the shopping module includes a shopping guiding module, and a product corresponding to the 3D product content is bought via the social network website.

In an embodiment, the social network module is accessing to Facebook, Twitter, or Instagram.

In an embodiment, the positioning module is infrared ray, Bluetooth, or GPS.

In an embodiment, the AR module is applied to AR glasses, an AR helmet, a smartphone with an AR function, a computer with an AR function, or a robot with an AR function.

In an embodiment, the shopping system further includes at least a visual effect module, and the visual effect module is connected with the AR module, and a visual effect function to the AR image is shown at the social network module.

In an embodiment, the shopping system further includes a paid member account module connected to the visual effect module, a designed visual effect for the visual effect function is provided according to a membership level.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram showing a shopping system according to an embodiment of the invention.

FIG. 2 is a schematic diagram showing a shopping system according to an embodiment of the invention.

FIG. 3 is a schematic diagram showing a shopping system at a virtual space state according to an embodiment of the invention.

FIG. 4 is a schematic diagram showing a use state of an identification image according to an embodiment of the invention.

FIG. 5 is a schematic diagram showing a use state of a shopping system according to an embodiment of the invention.

FIG. 6 is a schematic diagram showing a use state of a shopping system according to an embodiment of the invention.

FIG. 7 is a block diagram showing a social network module according to an embodiment of the invention.

### DETAILED DESCRIPTION

The structure, the proportion, and the size shown in the accompanying drawings in the specification are only used for illustration in cooperation with the contents disclosed in the specification, but not used for limiting the scope of the invention. The structure, the proportion, and the size which are adjusted according to requirements have the same effect are also in the scope of the invention. Moreover, the terms, such as “one”, “two”, “upper” and the like in the specification are used for simplicity and clarity, but not used for limiting the scope of the invention. The relative relation can be changed or adjusted without departing from as the scope of the invention.

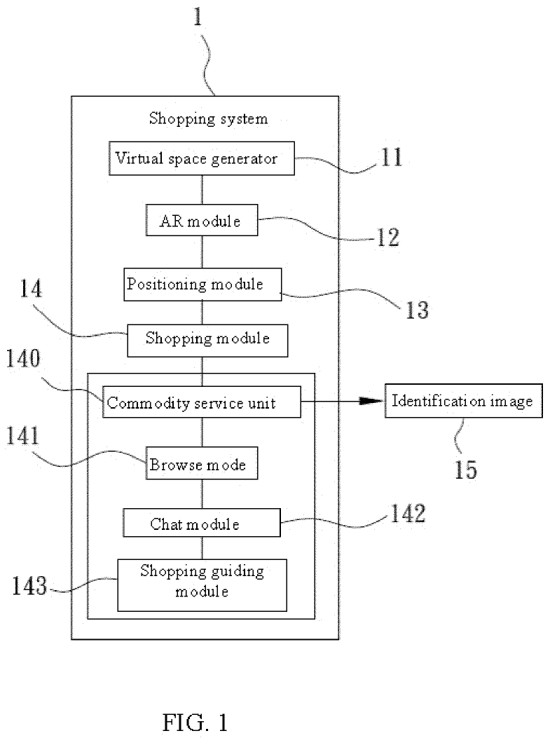

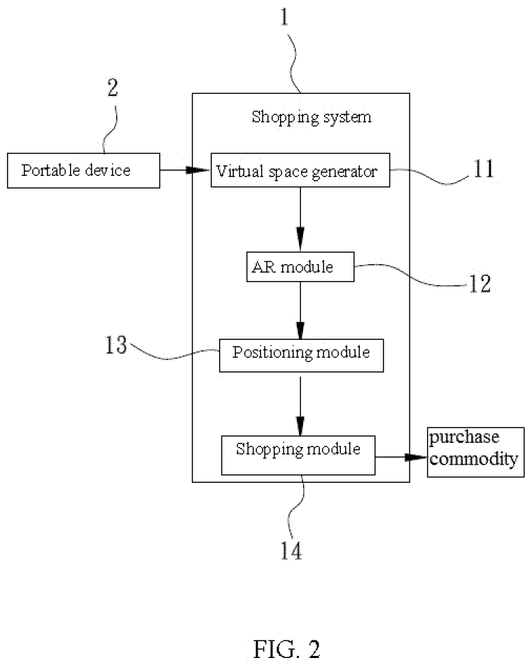

FIG. 1 and FIG. 2 are schematic diagrams showing a shopping system with virtual reality technology according to an embodiment of the invention. The shopping system is incorporated with an application program (APP) and run at an portable device (such as a mobile phone). The shopping system with virtual reality technology includes a virtual space generator 11, an augmented reality (AR) module 12, a positioning module 13 (such as infrared ray, Bluetooth, or GPS) and a shopping module 14.

The AR technology is a mode of combining an entity with virtual technology to provide a real environment. The AR is wildly used at video games, environment guiding, commercial applications and so on. Moreover, the AR module 12 can be used for detecting and tracking a real object in the image by utilizing an image recognition technology. The preset virtual object and the real object are combined to be displayed on a screen by utilizing the three-dimensional (3D).

The virtual space generator 11 is configured to provide a virtual space. The AR module 12 is configured to generate an AR image, and the AR image is loaded to the virtual space generator. The AR module 12 can be applied to AR glasses, an AR helmet, a smartphone with an AR function, a computer with an AR function, and a robot with an AR function.

The positioning module 13 is used for positioning of the portable device. Furthermore, the positioning module 13 loads the virtual space to change the movement position of a view point of the virtual space. The shopping module 14 and the AR module 12 are connected via the positioning module 13. Commodity information of an identification image 15 is obtained and loaded to the virtual space generator to generate the 3D product content.

In an embodiment, the application program (APP) is installed on the portable device (such as a mobile phone). The AR and the visual effect function are enabled. After the QR codes are scanned via the lens of the portable device, the virtual space (such as a view in the window or a dimension door) is shown at the portable device. The virtual door can be entered to go to different virtual spaces. The positioning module 13 is configured to detect the position of the user in the space. After the user is detected in front of the door or behind the door, different viewed can be seen.

In an embodiment, the system is used for praying. After the target QR codes are scanned, offerings are shown. The incense is burn after a while, and offerings are moved upwardly.

In an embodiment, the shopping module 14 further includes a commodity service unit 140, a browse mode 141, a chat module 142, and a shopping guiding module 143. The commodity service unit 140 is configured to write the commodity information of the commodity to the identification image 15 (such as two-dimensional codes and the QR codes). At the browse mode 141, the commodity information can be obtained via the portable device, and the full information (such as specification, price, manufacturing location, and related website) can be seen directly. The chat module 142 is used for the communication between the user and the remote customer service. After the commodity is selected and confirmed, the commodity transaction can be completed via the shopping guiding module 143.

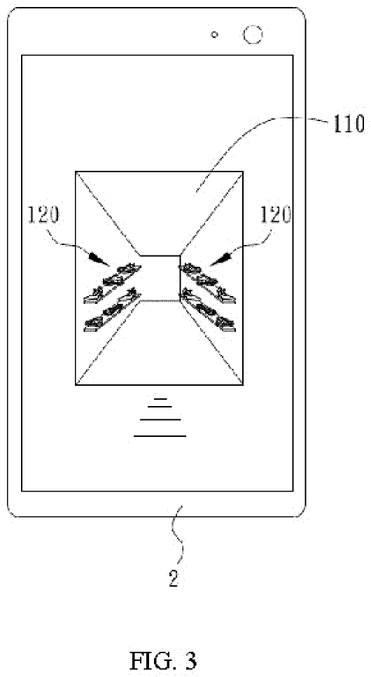

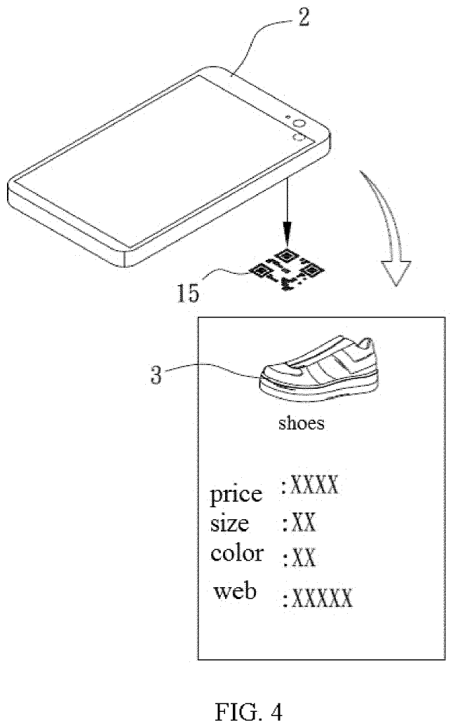

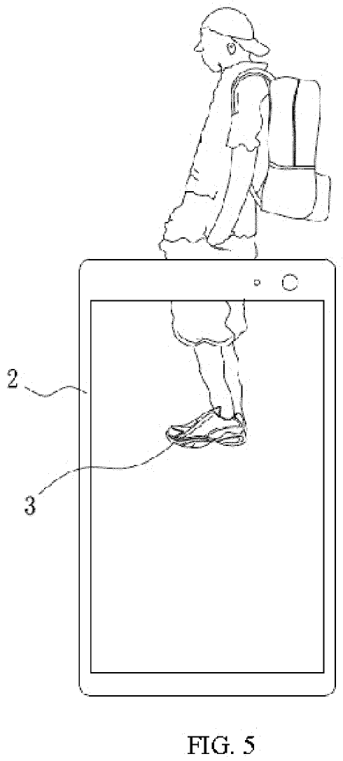

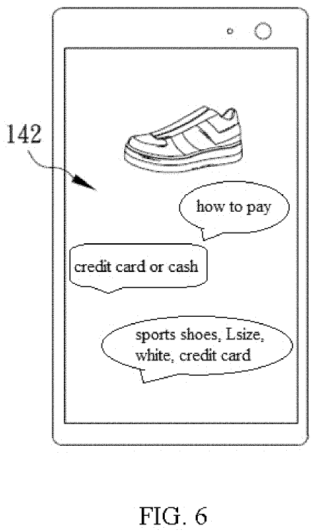

FIG. 3 is a schematic diagram showing a shopping system at a virtual space state according to an embodiment of the invention. FIG. 4 is a schematic diagram showing a use state of an identification image according to an embodiment of the invention. In FIG. 5, a virtual wearing state of the commodity (shoes in the embodiment) is shown. In FIG. 6, the communication interface is shown according to an embodiment. In FIG. 3, the application program of the shopping system 1 (please refer to FIG. 1) is enabled via the portable device 2. Then, the virtual space generator 11 of the enabled application program generates the virtual space 110. An AR image 120 is generated via the AR module 12 and imported into the virtual space generator 110.

In the embodiment, the virtual space 110 is a shopping environment. The AR image 120 generated by the AR module 12 is a shop doorway. When the user moves, the position and orientation of the portable device 2 is determined via the positioning module 13 (such as infrared ray, Bluetooth, or GPS). Thus, when the portable device 2 moves, the virtual space 110 is changed accordingly via the positioning module 13. When the user is detected to move towards the shop doorway, the shop doorway gets closer via the display of the portable device 2. When the user is detected to get into the shop doorway, the shopping environment set in the virtual space 110 is entered.

In FIG. 4, the identification images 15 of the commodity are read via the lens of the portable device 2. The commodity information of the commodity is accessible via detection of the identification image 15 (two-dimensional codes or QR codes) via the commodity service unit 140. When the identification image 15 is read via the operation of the user, the related information is shown via the browse mode 141.

In the embodiment, the information of the identification image 15 is the shoes 3. After the identification image 15 is read, the 3D product content and the information (such as specification, price, manufacturing location, and related website) of the shoes 3 in the commodity service unit 140 are imported to the virtual space generator 110.

In FIG. 5, after the shoes 3 are selected by the user, the commodity can be matched with the background in the virtual space 110. That is, the image is captured via the lens of the portable device 2 to get the background, and then the commodity is matched with the background.

In an embodiment, after the shoes 3 are selected and the selection is confirmed, the image of the foot of the user is captured via the lens of the portable device 2. The 3D product content of the shoes 3 are matched with the foot at the display of the portable device 2. Then, the visual effect of the shoes worn by the user can be seen directly. In an embodiment, the shoes are matched with the shoe cabinet which is captured via the lens of the portable device 2. Then, whether the shoes can be accommodated in the shoe cabinet can be seen.

In FIG. 6, after the shoes 3 are determined, the chat module 142 cooperating with a social network website (such as Facebook, Twitter, or Instagram) is used for the communication between the user and the remote customer service. The social network website includes the 3D product content. The instant conversation is built between the social network website and the portable device. The related information of the commodity (such as special offers, the mode of payment) can be asked and answered instantly via the instant conversation with the remote customer service of the commodity. After the commodity is confirmed, the commodity is bought using the 3D product content at the social network website via the shopping guiding module 143.

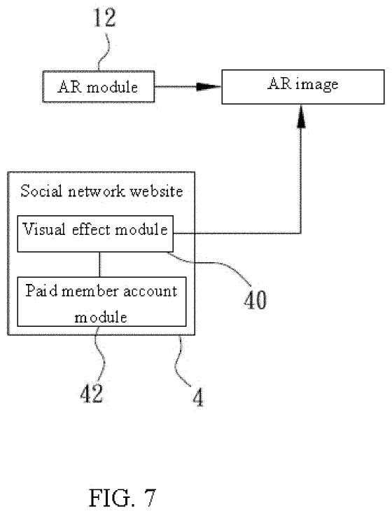

FIG. 7 is a block diagram showing a social network module according to an embodiment of the invention. The social network website 4 includes a visual effect module 40 and a paid member account module 42. The visual effect module 40 is connected with the AR module 12. The visual effect function to the AR image is shown at the social network module 4. The paid member account module 42 is connected to the visual effect module 40. The designed visual effect for the visual effect function is provided to users according to the membership level of membership, which can achieve devised visual effects.

In the embodiment, the virtual space 110 is generated via the virtual space generator 11. The AR image is generated via the AR module 12 and imported to the virtual space generator 110. Then, the position of the portable device 2 is located via the positioning module 13. Moreover, the position is imported to the virtual space generator 110 to change the movement position of a view point in the virtual space 110 accordingly. In an embodiment, the AR image is a shop doorway. The movement position of a view point can be obtained via the positioning module 13 when the portable device is operated by a user. When the user is detected to get closer to or enter into the shop doorway, the virtual space generator 11 generates the virtual space. Different AR images can be imported to the virtual space generator.

In an embodiment, the system is applied to commodity shopping. The commodity service unit 140, the browse mode 141, the chat module 142, and the shopping guiding module 143 are combined with the system. The reality images of products in the commodity service unit 140 are imported to the virtual space generator 110. Then, the detail of the commodity can be provided for consumer in the virtual space 110. The commodity can be matched with backgrounds according to requirements of users. Then, customers can place an order via the shopping guiding module 143. The shopping experience and enjoyment are improved. Moreover, the return rate is decreased due to the matching with the background.

In an embodiment, multiple connected ARs and multiple connected filters are provided to guild shopping and purchasing. For example, the commodity is a phone. Functions of the phone are shown at the display screen for customers (users). After the environment of the AR is finished, the dialog box is displayed at the display screen. In an embodiment, a chatbot is provided to ask the try feeling of user and further ask whether to buy the phone. The detail of the commodity and the function of the commodity are provided via the AR. When the custom determines to place an order, the payment can be finished at the website.

The function of the chatbot can be applied at the social network websites and so on. In the embodiment, the commodity is the shoes. The shoes can be shown at different virtual spaces. For example, the shoes are matched with the virtual space of the shoe cabinet or clothes and trousers. Customers can see the matching effect of the commodity at different environments. The functions and the detail structure of the commodity can be obtained clearly.

In an embodiment, the AR is configured to guild users to download the APP. The APP includes a guiding download mode. The APP can be installed at the exhibition place. Then, the APP is enabled by customers. The games in the AR can be played. The game experience can be uploaded and shared with others via website. If the APP is recommended by the custom, the dialog box is shown at the display of the phone to guild the download of the game app.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A shopping system with virtual reality technology, the shopping system being incorporated with an application program (APP) and run in a portable device, and the shopping system comprising:
a virtual space generator configured to generate a virtual space;
an augmented reality (AR) module configured to generate an AR image, the AR image is imported to the virtual space generator;
a positioning module configured to obtain a position and orientation of the portable device and import the position and orientation to the virtual space generator to change a movement position of a view point in the virtual space; and
a shopping module connected with the AR module and configured to obtain commodity information of an identification image, wherein the commodity information is imported to the virtual space generator to generate a 3D product content.

2. The shopping system of claim 1, wherein the shopping module comprises a commodity service unit, and the commodity information generated by the shopping module is accessible via detection of the identification image.

3. The shopping system of claim 2, wherein the shopping module provides a browse mode, and the 3D product content with the commodity information is imported to the virtual space generator and displayed on a display screen of the portable device when in the browse mode.

4. The shopping system of claim 3, wherein the shopping module further comprises a chat module integrating with social network website including the 3D product content, and an instant conversation channel is built between the chat module and the portable device via the chat module.

5. The shopping system of claim 4, wherein the shopping module further comprises a shopping guiding module, and a product corresponding to the 3D product content is bought via the social network website.

6. The shopping system of claim 5, wherein the social network module is accessing to Facebook, Twitter, or Instagram.

7. The shopping system according to claim 1, wherein the positioning module is infrared ray, Bluetooth, or GPS.

8. The shopping system of claim 1, wherein the AR module is applied to AR glasses, an AR helmet, a smartphone with an AR function, a computer with an AR function, or a robot with an AR function.

9. The shopping system of claim 1 further comprising at least a visual effect module connected with the AR module, wherein a visual effect function to the AR image is shown at the social network module.

10. The shopping system of claim 9, wherein the shopping system further includes a paid member account module connected to the visual effect module, and a designed visual effect for the visual effect function is provided according to a membership level.
